(19) United States
(12) Patent Application Publication
(10) Pub. No.: US 2026/0349412 A1
(43) Pub. Date: Nov. 5, 2026

(54) METHOD AND SYSTEM FOR ADAPTING A MANUFACTURING PROCESS

(71) Applicant: Primetals Technologies Germany GmbH, Erlangen (DE)

(72) Inventors: Rüdiger DÖLL, Nürnberg (DE); Karola GURRATH, Uttenreuth (DE); Hans-Ulrich LÖFFLER, Erlangen (DE); Rolf Martin REIN, Fürth (DE); Susanne SPARRER, Erlangen (DE); Alexander THEKALE, Erlangen (DE)

(21) Appl. No.: 19/120,288

(22) PCT Filed: Sep. 8, 2023
(86) PCT No.: PCT/EP2023/074699

§ 371 Date: Apr. 11, 2025

(30) Foreign Application Priority Data
Oct. 11, 2022 (EP) 22200883.1

(51) Int. Cl. G05B 19/4155

(52) U.S. Cl. CPC G05B 19/4155; G05B 2219/49057

(57) ABSTRACT

A method and a system for adapting a manufacturing process (P), in particular a hot rolling process, in which i) a product property (E*) of a process product is specified (S1); ii) an operating starting point (X) of a facility, in particular a hot rolling facility which is configured to carry out a manufacturing process (P) to produce the process product, is specified (S2); iii) the process product is produced in that the manufacturing process (P) is carried out (S3) with the aid of the facility starting from the specified operating starting point (X); iv) an actual product property (E) of the produced process product is ascertained; and v) an optimized operating point (X*) of the facility is ascertained (S5) on the basis of the specified product property (E*) and the ascertained actual product property (E) with the aid of an optimizer.

### TECHNICAL FIELD

The present invention relates to a method and a system for adapting a manufacturing process, in particular a hot rolling process.

### PRIOR ART

To put facilities into operation, such as hot rolling facilities, it is typically necessary to correctly set greatly varying parameters of the facility in order to be able to obtain a product having desired properties in the later operation of the facility.

For this purpose, creating a model of the facility and then calculating it through with the specification of a target value which represents the desired product properties is known. Assumed external influences, for example in the form of parameterized environmental conditions, and model parameters (so-called putting into operation parameters, abbreviated PIO parameters, which control the model behavior or parameterize regulation curves) are expediently used as input variables of the model. Such a model can output manipulated variables, using which the facility is operable. At least individual model parameters can optionally be optimized in that the facility is operated multiple times using the initially calculated manipulated variables and the properties of the product produced in this case are compared to the desired properties.

For example, an optimization method for a model of a facility of the raw materials industry is known from WO 2018/192798 A1. A control unit ascertains, using the model and predetermined target variables for an output product, an associated desired target operation of the facility (set up calculation). The model is parameterized using a plurality of characteristic variables (=model parameters) of the facility to be modeled). After the production of a plurality of output products, actual variables of the output products are compared with expected variables of the output products, and first model parameters are re-ascertained on the basis thereof and the model is accordingly re-parameterized. The expected variables are ascertained in this case by means of the model on the basis of the actual operation of the facility.

It is problematic in this case, however, that the facility put into operation once on the basis of the selected model input variables is typically subjected to changing external influences and/or the same manipulated variables result in different product properties over longer periods of time, for example due to aging/wear of the facility.

In addition, there are also manufacturing processes which are too complex for sufficiently precise modeling or the modeling of which is extremely time-consuming or computing-intensive in any case. If a sufficiently precise model cannot be found or used, the PIO parameters also cannot be automatically optimized via an algorithm. In such cases, the PIO parameters have to be manually ascertained. However, this requires a large amount of experience of the corresponding personnel and is also very time-consuming.

For optimized regulation of the thickness quality in a rolling process, providing an online process model which also carries out an adaptation of model parameters by identifying variable process parameters is known from EP 1 488 863 A2. By means of an adaptation unit, which communicates with the online process model, an adaptation of regulation parameters is carried out on the basis of the adapted model parameters and the adapted regulation parameters are applied online for implementing and adapting regulation functions and/or loops of a model-based multi-variable regulation unit.

DE 195 08 476 A1 discloses a guidance system for a facility of the raw materials industry or the processing industry, which is designed by computer technology building on input prior knowledge to independently identify the status of the facility and details of a production process running in the facility and to output situation-appropriate instructions, such as setting values, to achieve a reliable production result. The situation-appropriate instructions are optimized in predetermined optimization routines, wherein the input prior knowledge is continuously improved by knowledge obtained internally by computing on the process model during the production.

### SUMMARY OF THE INVENTION

Against this background, it is an object of the present invention to specify an improved method and an improved system, using which even complex manufacturing processes are automatically adaptable and/or properties of process products can be kept constant over long periods of time.

These objects are achieved by a method and a system for adapting a manufacturing process according to the independent claims.

Preferred embodiments are the subject matter of the dependent claims and the following description.

In the method according to the first aspect of the invention, for the adaptation, in particular the automatic adaptation, of a manufacturing process, in particular a hot rolling process, i) a product property of a process product is specified. Moreover, ii) an operating starting point of a facility, in particular a hot rolling facility, which is configured to carry a manufacturing process to produce the process product, is specified and iii) the process product is produced in that the manufacturing process is carried out with the aid of the facility starting from the specified operating starting point. iv) an actual product property of the produced process product is ascertained and v) an optimized operating point of the facility is ascertained on the basis of the specified product property and the ascertained actual product property with the aid of an optimizer.

A manufacturing process within the meaning of the invention is preferably a technical process in which a product is manufactured, i.e. produced. The product does not necessarily have to be a “finished” (final) product, rather it can also be a semi-finished product. A manufacturing process can insofar also be a part of a greater production process of a final product, such as hot rolling a slab, in particular a width forming with the aid of a vertical stand carried out in the roughing train.

An optimizer within the meaning of the invention is preferably a means for solving an optimization problem, in particular iteratively. For example, an optimizer can be configured to ascertain one or more values for process parameters, using which a process supplies a desired result. The optimizer expediently uses a specified optimization strategy in order to solve the optimization problem. For example, process parameters selected according to the optimization strategy can be varied and the variation of the process parameters can be adapted starting from the process result thus resulting, so that the process result converges toward the desired result.

An optimizer is preferably based on an optimization algorithm. The optimization algorithm can embody the optimization strategy. An execution of a manufacturing process with the aid of a facility starting from a specified operating starting point within the meaning of the invention preferably means operating the facility at the specified operating starting point or at least at an operating point which is ascertained on the basis of the specified operating starting point. However, it can occur that in spite of a corresponding setting of operating parameters, the facility does not work at the desired operating point, for example the specified operating starting point. Such an execution of the manufacturing process can advantageously also be understood, however, as an execution with the aid of the facility starting from the specified operating starting point.

One aspect of the invention is based on the approach of using an optimizer to ascertain an optimum operating point, at which a facility produces a process product having a specified product property, in conjunction with the (real) operation of the facility. In particular, an optimization strategy underlying the optimizer can be implemented here by an operation of the facility. The facility can insofar be iteratively operated by the optimizer to ascertain the optimum operating point (or an operating point which is at least very close to the optimum operating point). The optimizer expediently specifies boundary conditions in this case, for example a variation of operating parameters of the facility or the corresponding operating parameter values under which the facility is to be operated. By way of an analysis of the manufacturing process executed using the facility operation, in particular the produced process product, the optimizer can propose optimized operating parameter values which are expected to enable the production of the process product with a product property which is closer to the specified product property. It is not necessary here for the optimizer to evaluate a model or a so-called (mathematically formulated) target function which characterizes the manufacturing process. The implementation of the optimization strategy by the (real) operation of the facility or the evaluation of the manufacturing process connected thereto, in particular over a longer period of time, advantageously also permits the consideration of changing operating conditions here. For example, the changes of external influences and/or changes of the facility condition due to aging, for example, can be taken into consideration.

To adapt a manufacturing process, an optimization algorithm can be divided, for example, into individual calculation steps. Advantageously, at the end of each calculation step, an evaluation of the manufacturing process using process parameter values specified by the optimization algorithm, i.e. at a specified operating starting point, is appropriate here. This evaluation is preferably carried out by operating the facility starting from the specified operating starting point, which is characterized by the specified process parameter values. In this respect, instead of calling up a target function for a specific parameter composition, the evaluation of an actual physical process for precisely that parameter composition can take place here. The result of the evaluation can then be used as the basis for the calculation of updated process parameter values, i.e. an optimized operating point, in the next calculation step.

The evaluation of the manufacturing process preferably takes place here by ascertaining an actual product property of the process product produced by the manufacturing process. In particular, the ascertained actual product property can be compared with the specified product property. The comparison result can represent a quality of the actual product property of the produced process product. Starting from this quality, the optimizer can determine optimized process parameter values, i.e. an optimized operating point for the facility.

With the aid of such a method for adapting a manufacturing process, the effort- and therefore also the costs-for putting a facility into operation can be significantly reduced in relation to manual methods. At the same time, a uniformly good quality of the process products produced with the aid of the facility can be ensured. In particular, an optimum operating point of the facility can easily be adapted if new product spectra are produced or the facility condition changes.

Preferred embodiments of the invention and the refinements thereof are described hereinafter. These embodiments can each be combined arbitrarily with one another and with the aspects of the invention described hereinafter, if not expressly precluded.

In one preferred embodiment, the production of the process product with the aid of the facility is carried out instead of the evaluation of a mathematical target function by the optimizer. The manufacturing process can thus be adapted with the aid of a conventional optimizer, in particular a conventional optimization algorithm. For example, a facility for which a model or a mathematical target function cannot be created can thus also be put into operation with the aid of a conventional optimizer.

According to the invention, the method is preferably continuously repeated using the specified product property, i.e. while maintaining the specified product property. In particular, an optimum operating point can be redetermined or updated progressively in regular operation of the facility. Changes of the operating conditions, for example changes of the external influences or changes of the facility properties due to aging or wear, for example, can thus be compensated for if necessary and therefore a uniformly good quality of the process products can be achieved.

The respective ascertained optimized operating point is expediently specified here in the repetition, in particular the corresponding following repetition, as the operating starting point. The optimizer can insofar check starting from a previously ascertained optimized operating point whether the operation of the facility is possible at an operating point that is more suitable with respect to the specified product property. A convergence, which is in particular permanent, of the actual product property toward the specified product property can therefore be ensured.

Alternatively, the respective ascertained optimized operating point can be used as the basis in the repetition, in particular the corresponding following repetition, of a specification of the operating starting point. In other words, the operating starting point can be specified in that the operating starting point is ascertained starting from the ascertained optimized operating point, for example derived from the ascertained optimized operating point. It is conceivable, for example, that one or more operating points in the vicinity of the ascertained optimized operating point are specified as the operating starting point. An operating point in the vicinity of the ascertained optimized operating point can be ascertained here in consideration of specified rules, i.e., for example, by a specified selection or ascertainment process, for example according to a specified optimization strategy. In this way, the convergence of the actual product property toward the specified product property can be accelerated under certain circumstances.

However, it is also conceivable that the operating starting point is randomly selected starting from the ascertained optimized operating point. In principle, the specified operating starting point also does not have to be in the vicinity of the ascertained optimized operating point.

In a further preferred embodiment, multiple process products are produced in that the manufacturing process is carried out with the aid of the facility in different operating points starting from the specified operating starting point. In other words, the behavior of the facility—and therefore the corresponding manufacturing process—can be tested at multiple operating points before the optimizer ascertains an optimized operating point. For example, the manufacturing process can be carried out with the aid of the facility at different operating points in the vicinity of the specified operating starting point. In this way, in particular so-called gradients for various process parameters can be ascertained, on the basis of which the optimizer ultimately ascertains the optimized operating point.

The different operating points can be selected starting from the specified operating starting point, for example from a previously ascertained optimized operating point, by a variation of at least one operating parameter of the facility. It is to be noted here that if the manufacturing process is carried out repeatedly at the same operating point of the facility, the actual product property is never precisely identical. Such spreads, which can also be referred to as natural noise of the process, are generally unavoidable since every facility component is only “precise” within a certain tolerance range. As a result, a standard deviation can be ascertained as a measure of the spread of the product property. The operating parameter is therefore preferably changed strongly enough to ascertain the operating points that the product property changes by more than the standard deviation of the product property. Against this background, an operating point in the vicinity of the specified operating starting point is preferably an operating point which is obtained starting from the specified operating starting point by a variation of an operating parameter of the facility of at most 10%, preferably at most 5%, in particular at most 2%, as long as the change of the product property connected thereto is greater than the standard deviation of the product property. Other operating parameters expediently remain unchanged in this case.

The actual product property is expediently ascertained for every produced process product. Accordingly, it is preferred for the optimized operating point to be ascertained on the basis of the specified product property and the multiple ascertained actual product properties. The optimizer can insofar check in which of the different operating points—i.e. with which process parameter variations—the best result is achieved with respect to the specified product property. The corresponding operating point can be provided as the most promising candidate to achieve the specified product property as the optimized operating point, for example as a new starting point for the optimization process. To be able to enable an effective sequence of the method, in a further preferred embodiment, the spread of actual product properties of process products, which are obtained when the manufacturing process is carried out repeatedly at the same operating point of the facility, is ascertained. For example, the standard deviation can be ascertained as a measure of the spread of the product property. The measure of the ascertained spread is preferably used as the basis of an ascertainment of the different operating points. In other words, a distance, in particular a minimum distance, between the various operating points and/or from the specified operating starting point, for example the last ascertained optimized operating point, can be established on the basis of the ascertained spread. For example, the strength of the variation of at least one operating parameter of the facility can depend on the strength of the ascertained spread. It can thus be ensured that a difference between the ascertained actual product property and the specified product property originates from a change of the operating point and not only from “noise”.

The different operating points in the vicinity of the specified operating starting point are preferably determined by variation of one of multiple operating parameters in each case. This expediently corresponds in each case to the variation of a process parameter. Each variation of an operating parameter can represent a gradient formation in one direction in the corresponding parameter space. The gradients ascertained in this way for various operating parameters are expediently linearly independent, in a refinement even orthogonal to one another, in the operating parameter space. On the basis of the respective ascertained actual product properties corresponding with the variations or the gradients formed, the optimizer can decide in which direction in the parameter space the search for an optimum operating point is to be continued.

In a further preferred embodiment, multiple process products are produced in that the manufacturing process is carried out repeatedly at the same operating point with the aid of the facility. The product property corresponding with the operating point can therefore be determined more precisely. In particular, a standard deviation, which is used as a measure for possibly occurring spreads with respect to the product property of the respective produced process product, can be ascertained.

Expediently, the actual product property is ascertained accordingly for each produced process product and the optimized operating point is ascertained on the basis of the specified product property and a location parameter of the multiple ascertained actual product properties. A location parameter is preferably to be understood in this case as a mathematical summary of the multiple ascertained actual product properties, in particular a characteristic number of the random sample embodied by the multiple ascertained actual product properties. Such a location parameter can be, for example, an arithmetic mean, a median, a mode, or the like of the multiple ascertained actual product properties.

For example, the manufacturing process can be carried out with the aid of the facility at least three times, preferably at least four times, in particular at least five times at the same operating point. It has been shown that using such a number of manufacturing processes per operating point, i.e. of manufactured process products, variations in the actual product property can be reliably recognized and taken into consideration accordingly, for example averaged out. At the same time, with this number of manufacturing processes per operating point, the resulting effort is still manageable.

In a further preferred embodiment, the optimizer ascertains the specified operating starting point as the optimized operating point if a difference between the specified product property and the ascertained actual product property, in particular a target value representing the actual product property and a specified target value representing the specified product property, reaches or falls below a threshold value. In other words, the optimizer does not propose a new operating point as the operating starting point if the ascertained actual product property substantially corresponds with the specified product property. A bound can thus be introduced which can prevent a continuous change of the operating point during successive productions of the process product in the range of the optimum operating point. As a result, a uniform quality of the process product can be ensured in normal operation of the facility.

It is advantageous here if a number of performances of the manufacturing process with the aid of the facility at the same operating point for the most precise possible determination of the actual product property at the operating point is increased depending on the difference between the specified product property and the ascertained actual product property, preferably until reaching or falling below the threshold value. The repetition number is expediently selected such that the standard deviation of the product property is less than the difference. The threshold value can accordingly be selected as a value toward which the standard deviation of the product property converges with a high number of repetitions of the manufacturing process.

In a further preferred embodiment, the optimizer is configured to recognize whether more than one optimum operating point exists for the production of a process product having the specified product property. It is conceivable, for example, that a special material quality of a long flat rolled stock is achievable using the operation of a rolling stand at different operating points. In this case, at least one of the ascertained operating points which are equivalent with regard to the specified product property is expediently output as the optimized operating point. The recognition can in principle take place online during the manufacturing process or offline using recorded data of the manufacturing process.

If the specified operating starting point is in a limit range of the performance of the facility, it can occur that in spite of setting operating parameters corresponding to the operating starting point, the facility does not work at the desired operating point. In a further preferred embodiment, it is therefore checked whether the operation of the facility meets at least one specified criterion when carrying out the manufacturing process. In particular, it can be checked whether the manufacturing process was carried out at the specified operating starting point or at least in the vicinity thereof. For this purpose, recorded data of the manufacturing process, for example manipulated variables of the facility, can be evaluated.

If it is established that the manufacturing process was not carried out with the aid of the facility at the desired operating point, for example not at the specified operating starting point or not even in the vicinity thereof, the ascertainment of the optimized operating point can take place in various ways. As a result, it is preferred for the optimized operating point of the facility to be ascertained depending on a result of the check. For example, it is conceivable that the production of the process product at the specified operating starting point is repeated once again in the hope that the operation of the facility will now meet the specified criterion. Alternatively, a new operating starting point can be specified which is closer to an operating point at which the operation of the facility meets the criterion. If the optimizer specifies the operating starting point, for example starting from an operating point, for example a previously ascertained optimized operating point, and it is shown that at this specified operating starting point the criterion is not met, the optimizer can specify an operating point which lies between the specified operating starting point and the previously ascertained optimized operating point as a new operating starting point.

However, it is also conceivable that the ascertained actual product property will be accepted and used to ascertain the (next) optimized operating point, although the criterion is not met. For example, the ascertained actual product property can be compared with a prediction of the optimizer. If the actual product property is closer to the specified product property than a product property predicted for the specified operating starting point, the (next) optimized operating point is preferably ascertained on the basis of the actually ascertained product property.

In a further preferred embodiment, the optimized operating point is ascertained by the optimizer by means of a trust-region method and/or a line-search method. In particular, the optimized operating point can be ascertained with the aid of a sequential quadratic programming (SQP) variant of the trust-region method. The optimizer preferably ascertains a “correction” of the operating point in the sense of the trust-region method starting from the specified operating starting point, in particular using the SQP variant by solving a square minimization problem under secondary conditions. The “usability” of this correction is expediently then measured by producing the process product with the aid of the facility at the optimized operating point and, for example, a comparison of the corresponding actual product property with the specified product property. Depending on a result of this “measurement”, the secondary conditions of the square minimization problem can be changed in order to be able to perform a qualified correction of the (new) operating starting point in a further iteration of the method.

The optimizer insofar preferably has an optimization algorithm, in particular in the form of the SQP variant of the trust-region method or reinforcement learning. In principle, however, other optimization algorithms are also conceivable. To be able to enable an adaptation to changed operating conditions, for example changed external influences or aging of the facility, the optimization algorithm preferably does not have a termination criterion. The optimization of the operating point or the method insofar preferably does not end even if the ascertained actual product property substantially corresponds to the specified product property. This is because changed operating conditions at a later point in time can have the result that the operation of the facility is necessary at a different (optimum) operating point in order to still be able to produce the process product having the specified product property.

The method is insofar in particular suitable in this embodiment, but also in all other above-described embodiments or combinations thereof, for regular, in particular permanent, operation of a facility.

According to a second aspect of the invention, the method according to the first aspect of the invention is therefore used for the regular operation of a facility, in particular a hot rolling facility. The facility can operate substantially continuously in normal operation here while the optimizer ascertains iteratively optimized operating points and the facility is operated after each iteration at the respective ascertained optimized operating point. This process can be completely auto-mated so that effort and therefore also costs can be significantly reduced not only for putting into operation, but also in regular operation of the facility.

A system according to a third aspect of the invention for the adaptation, in particular automatic adaptation, of a manufacturing process, in particular a hot rolling process, comprises a facility for producing a process product. The facility is preferably a hot rolling facility, in particular a vertical rolling stand for rolling long flat products having a downstream horizontal rolling stand of long flat products. The process product is expediently producible in that a manufacturing process is carried out with the aid of the facility in the vicinity of a specified operating starting point. The system furthermore comprises a means for ascertaining an actual product property of the produced process product and an optimizer, which is configured to ascertain an optimized operating point for the facility on the basis of a specified product property of the process product and the ascertained actual product property. Such a system permits the evaluation of the manufacturing process under boundary conditions specified by the optimizer, in particular selected by test, in order to find optimum values or at least values approaching optimum values for operating parameters. The system moreover also enables the consideration of changing operating conditions in regular operation, for example the change of external influences, changes of the facility condition, for example due to aging, and/or a change of the processed, for example rolled, materials.

The facility can be an industrial facility, for example a hot rolling facility. The facility can have, for example, a casting machine for producing a metallic strip from molten metal, in particular slabs, a vertical rolling stand (which is sometimes also referred to as an edge former), and a horizontal rolling stand for reducing the thickness of the slabs.

The means for ascertaining an actual product property can have a sensor arrangement, which can sensorially detect the process product, for example the slab, and can ascertain the actual product property from the produced sensor data.

The optimizer can be designed in hardware and/or software. The optimizer can in particular have a processing unit, which is preferably connected to a memory and/or bus system with respect to data and/or signals. For example, the optimizer can have a central processing unit (CPU) or a module of such a unit and/or one or more programs or program modules. The optimizer can be designed to process commands which are implemented as a program stored in a storage system, to detect input signals from a data bus, and/or to emit output signals to a data bus. A storage system can have one or more, in particular different storage media, in particular optical, magnetic, solid-state, and/or other nonvolatile media. The program can be of a nature such that it is capable of at least partially embodying or carrying out the method described here, so that the optimizer can carry out at least individual steps of such methods and therefore can in particular ascertain an optimized operating point of the facility.

### BRIEF DESCRIPTION OF THE DRAWINGS

The above-described properties, features and advantages of this invention, and the manner in which these are achieved, will become clearer and more clearly understandable in conjunction with the following description of one exemplary embodiment which will be explained in more detail in conjunction with the drawings, In the figures, which are at least partially schematic:

FIG. 1 shows an example of a conventional method for putting a facility into operation;

FIG. 2 shows an example of a system for adapting a manufacturing process; and

FIG. 3 shows an example of a method for adapting a manufacturing process.

If expedient, the same reference signs are used in the figures for the same or corresponding elements of the invention.

### DESCRIPTION OF THE EMBODIMENTS

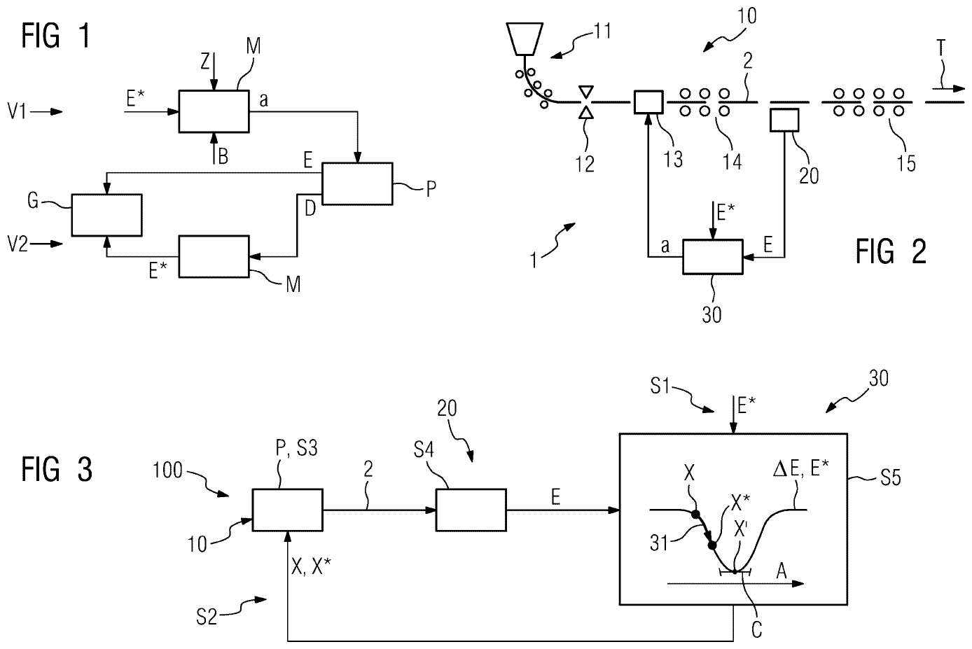

FIG. 1 shows an example of a conventional method for putting a facility into operation, which is configured to carry out a manufacturing process P. Such manufacturing processes P are generally dependent on operating conditions B and operating parameters of the facility, which can adopt various operating parameter values a. Depending on the operating conditions B and, for example, operating parameter values a selected by a user, a product property E of the process product produced by the manufacturing process P varies.

In order to be able to produce process products having a specified product property E* using the facility or the manufacturing process that can be carried out using the facility, therefore the “correct” operating parameter values a have to be found. This process is referred to as putting into operation.

For this purpose, the facility or the manufacturing process P can be mapped using a model M. In addition to the operating conditions B and the desired specified product property E*, which can be characterized by a so-called target value, model parameters Z can be input as input variables into this model M. The model parameters Z, which are sometimes also referred to as putting into operation parameters (PIO parameters), can be parameters inherent to the model M, but alternatively or additionally can also be used for the setup calculation and/or can influence the sequence of an algorithm for evaluating the model M.

The evaluation of the model M in method step V1 using these operating conditions B, the specified product property E*, and the model parameters Z supplies operating parameter values a. In addition, reasonable sensitivities for a regulation of the facility or the manufacturing process P can possibly also be ascertained (not shown) with the aid of such a model M.

However, it has been shown in practice that the desired specified product property E* generally cannot be achieved precisely by the operation of the facility using the operating parameter values a ascertained in this manner. This is considered to be because of, among other things, the typically incomplete detection of all operating conditions B and the restriction inherent to the model M in the description of reality (a model M can never describe reality a hundred percent exactly).

Therefore, attempts can be made to optimize the model parameters Z in a further method step V2. The optimization takes place thereafter in this case, i.e. after the manufacturing process P is carried out with the aid of the facility at an operating point defined by the operating parameter values a supplied by the model M. Insofar reference is also made to offline optimization.

All relevant data D relating to the manufacturing process P are recorded for this offline optimization when the manufacturing process P is carried out with the aid of the facility. Using these data D, the model M can be evaluated once again-however, it is not operating parameter values a that are calculated now, but rather a product property E′ to be expected. A comparison of this product property E′ to be expected with the product property E actually achieved by the manufacturing process P supplies a quality G for the product property which is achievable by the manufacturing process P carried out using the model-ascertained operating parameter values a.

If the relationship between the model parameters Z and the quality G for the achievable product property, i.e. the achievable target value, is known, the model parameters Z can be optimized (offline) employing the data D using conventional optimization methods. The model parameters Z optimized in this manner finally permit the facility to be put into operation using the corresponding (optimized) operating parameter values a.

However, the described method is not applicable in cases in which there is no model M, which can describe the manufacturing process P well enough with acceptable effort. One example of such a manufacturing process P is the production of strips using a hot rolling facility. A typical specified product property E* is in this case a rectangular shape of the strip ends with a specified width at the end of the rolling process. The strip end shape is influenced in practice with the aid of a hydraulic angling of a compressing unit before a roughing stand of the hot rolling system. The goal when putting into operation is therefore to find the correct settings for the compressing unit.

The relationship between the compressing process and the strip end shape resulting after the rolling is extremely complex due to the material flow connected to the rollers, however. It therefore requires-if it is possible at all-an extremely high level of computing power in order to simulate the formation of the strip ends with specific compressing unit settings with the aid of a finite element calculation, for example. Such a model M is not suitable for use when putting a facility into operation for reasons of computing time and accuracy, however, and is not suitable at all for a continuous control of the compressing process.

In practice, a parameterized curve is therefore specified as a manipulated variable function for the compressing unit. The curve parameters have to be adapted manually to the operating conditions of the facility when putting it into operation. This requires a large amount of experience of the respective person putting into operation and a high time expenditure until the parameters are set for the entire production spectrum of the facility.

FIG. 2 shows a system 1 for adapting a manufacturing process, which can be carried out with the aid of a facility 10 and using which a process product 2 is producible. The facility 10 is designed in the present case as a hot rolling facility, which is configured for hot rolling a metal strip-which represents the process product 2 in this example. The hot rolling facility comprises a casting machine 11 for preferably continuous casting of the metal strip, a severing unit 12 for dividing the cast metal strip, a vertical rolling stand 13 for width reduction of the divided metal strip, a roughing stand 14 for a first thickness reduction of the divided metal strip, and a finishing stand 15 for a second thickness reduction of the divided metal strip. The hot rolling facility can have further components (not shown), for example one or more furnaces for (re-) heating the cast or divided metal strip, de-scaling stations for removing scale layers, further severing units for dividing the metal strip downstream from the roughing stand 14 and/or the finishing stand 15, and one or more coilers for winding up the divided metal strips onto coils. A transport device for transporting the process product 2 along a transport direction T is not shown.

The system 1 moreover has a means 20 for ascertaining an actual product property E of the process product 2 and an optimizer 30 for ascertaining an optimized operating point on the basis of the ascertained actual product property E and a specified product property E*.

The means 20 preferably has a sensor arrangement, using which the process product 2 is sensorially detectable. For example, the means 20 can have one or more sensors in the form of cameras, (distance) ultrasonic sensors, and/or the like.

The actual product property E of the process product 2 can expediently be ascertained on the basis of sensor data produced during the sensorial detection of the process product 2. The means 20 can be configured for this purpose in the variant shown. Alternatively, the evaluation of the sensor data with regard to the actual product property E of the process product 2 can also take place elsewhere, for example by the optimizer 30. The actually ascertained product property E is expediently provided at the optimizer 30 in any case.

In the example shown, the means 20 is arranged between the roughing stand 14 and the finishing stand 15 with respect to the transport direction T. However, other arrangements of the means 20 are also conceivable, for example downstream from the finishing stand 15.

The optimizer 30 can be designed in hardware and/or software. The optimizer 30 can have, for example, a computing means, for example a microprocessor, and/or a storage means connected to the microprocessor with respect to signals or data. The optimizer 30 can in particular have a dedicated hardware architecture designed for ascertaining an optimized operating point. The optimizer 30 can be designed as an ASIC, for example. Alternatively or additionally, the optimizer 30 can have, for example, one or more software modules which embody an optimization algorithm, for example.

The optimizer 30 is expediently connected via an interface to the facility 10 in order to cause operation of the facility 10 at the (newly) ascertained optimized operating point, in particular to be able to transmit correspondingly optimized operating parameter values a to the facility 10.

The vertical rolling stand 13 is configured to shape the lateral surfaces of the divided metal strip, which are sometimes also referred to as long sides, according to an angling curve so that the lateral surfaces do not extend linearly over the length of the divided metal strip. In other words, the vertical rolling stand 13 can influence the width of the divided metal strip. This specified course of the lateral surfaces is to be used as a compensation for the material flow produced during the rolling in the roughing stand 14—and possibly also in the finishing stand 15—so that a rectangular shape of the divided metal strip can be achieved after the roughing stand 14 or the finishing stand 15.

The angling curve is expediently characterized by one or more operating parameters, the values of which are specifiable by the optimizer 30. The optimizer 30 is therefore connected to the vertical rolling stand 13 with respect to signals or data in the present example. After the detection of each divided metal strip, in particular a measurement of the strip width in the starting and end areas of each metal strip, by the means 20, the optimizer 30 can vary at least one of the operating parameters and thus change the angling curve depending on the correspondingly ascertained actual product property E. The shape of the divided metal strips resulting therefrom can be detected again by the means 20 and the optimizer 30 can vary one of the operating parameters once again. A substantially square shape of the divided metal strips thus forms, for example after twenty such passes.

FIG. 3 shows an example of a method 100 for adapting a manufacturing process P.

In a method step S1, a product property E* of a process product 2 is specified, which is producible using the manufacturing process P. In a further method step S3, a facility 10 which is configured to produce the process product 2 by carrying out the manufacturing process P is operated at a specified operating starting point X. The operating starting point X is specified beforehand for this purpose in a method step S2.

In a further method step S4, an actual product property E of the process product 2 produced by the manufacturing process P is ascertained. For this purpose, a means 20 for ascertaining the actual product property E can be provided. For example, in method step S4, the produced process product 2 is sensorially scanned and the actual product property E is derived from the sensor data generated in this case.

The ascertained actual product property E is provided to an optimizer 30. In a further method step S5, the optimizer 30 ascertains an optimized operating point X* on the basis of the specified product property E* and the ascertained actual product property E, for example on the basis of a quality of the ascertained actual product property E with regard to the specified product property E*.

When ascertaining the optimized operating point X*, the optimizer 30 expediently uses an optimization algorithm 31, for example a trust-region method or a line-search method. Starting from the present operating starting point X of the facility 10, which is characterized by a specific combination of values for the operating parameters A of the facility 10, the optimization algorithm 31 can vary individual operating parameters A. The variation expediently takes place according to an optimization strategy underlying the optimization algorithm 31. For example, the optimization algorithm 31 can be configured to find a minimum in a potential landscape from the set of all operating points which reflects the difference ΔE,E* between the actual product property E and the specified product property E*. In the present example, this is indicated in a one-dimensional manner by a gradient determination upon variation of an operating parameter A.

The optimized operating point X* ascertained in method step S5 is expediently specified in a further iteration of the method 100 as the operating starting point X in method step S2. That is to say that the method 100 can be repeated from method step S2.

In contrast to conventional optimization methods, no termination criterion is provided for the method 100. That is to say that the facility 10 can also be operated in normal operation with the aid of the method 100. Even in the event of changing operating conditions, which require a changed operating point to produce the process product 2 having the specified product property E*, the facility 10 can thus automatically be transferred to this changed operating point.

To prevent the respective newly specified operating starting point from fluctuating constantly in a range C around the optimum operating point X′, at which the facility 10 produces a process product 2 having the specified product property E* or at least a product property very close thereto, however, bounds can be specified. For example, the specified operating starting point X can be output as the optimized operating point X* if a difference between the specified product property E* and the ascertained actual product property E reaches or falls below a threshold value. A “readjustment” of the operating point of the facility 10 can therefore be avoided as soon as the range C, for example the “bottom” of the minimum shown in FIG. 3, is reached.

Although the invention has been illustrated and described in more detail by the preferred exemplary embodiments, the invention is not limited by the examples disclosed, and other variations can be derived therefrom by a person skilled in the art without departing from the scope of protection of the invention.

### LIST OF REFERENCE SIGNS

1 system
2 process product
10 facility
11 casting machine
12 separating unit
13 vertical rolling stand
14 roughing stand
15 finishing stand
20 means for ascertaining an actual product property
30 optimizer
31 optimization algorithm
100 method
S1-S5 method steps
V1, V2 method steps
A operating parameter
a operating parameter value
B operating condition
E product property
E* specified product property
E′ product property to be expected
Z model parameter
M model
P manufacturing process
D data
G quality
T transport direction
X operating starting point
X* optimized operating point
X′ optimum operating point
C range
ΔE, E* difference

1. A method for adapting a manufacturing process (P), in particular a hot rolling process, comprising the following steps:
specifying (S1) a product property (E*) of a process product characterized by a target value;
specifying (S2) an operating starting point (X) of a facility, in particular a hot rolling facility, which is configured to carry out a manufacturing process (P) to produce the process product;
producing (S3) the process product in that the manufacturing process (P) is carried out with the aid of the facility starting from the specified operating starting point (X);
ascertaining (S4) an actual product property (E) of the produced process product;
ascertaining (S5) an optimized operating point (X*) of the facility on the basis of the specified product property (E*) and the ascertained actual product property (E) with the aid of an optimizer for iteratively solving an optimization problem using an optimization strategy;
repeating the method using the specified product property (E*), wherein the respective ascertained optimized operating point (X*) is specified as the operating starting point (X) or is used as the basis of a specification of the operating starting point (X) upon the repetition.

2. The method as claimed in claim 1, wherein
multiple process products are produced in that the manufacturing process (P) is carried out at different operating points starting from the specified operating starting point (X) with the aid of the facility,
for each produced process product, the actual product property (E) is ascertained, and
the optimized operating point (X*) is ascertained on the basis of the specified product property (E*) and the multiple ascertained actual product properties (E).

3. The method as claimed in claim 2, wherein the spread of actual product properties (E) of process products which were obtained when carrying out the manufacturing process (P) repeatedly at the same operating point of the facility is ascertained, and a measure of the ascertained spread is used as the basis of an ascertainment of the different operating points.

4. The method as claimed in claim 2, wherein the different operating points in the vicinity of the specified operating starting point (X) are determined by variation of one of multiple operating parameters (A) in each case.

5. The method as claimed in claim 1, wherein
multiple process products are produced in that the manufacturing process (P) is carried out repeatedly at the same operating point with the aid of the facility and
for each produced process product-(2), the actual product property (E) is ascertained, and
the optimized operating point (X*) is ascertained on the basis of the specified product property (E*) and a location parameter of the multiple ascertained actual product properties (E).

6. The method as claimed in claim 5, wherein the manufacturing process (P) is carried out at the same operating point with the aid of the facility at least three times.

7. The method as claimed in claim 1, wherein the optimizer ascertains the specified operating starting point (X) as the optimized operating point (X*) if a difference (ΔE, E*) between the specified product property (E*) and the ascertained actual product property (E) reaches or falls below a threshold value.

8. The method as claimed in claim 7, wherein a number of times the manufacturing process (P) is carried out with the aid of the facility at the same operating point is increased depending on the difference (ΔE,E*) between the specified product property (E*) and the ascertained actual product property (E).

9. The method as claimed in claim 1, wherein the optimized operating point (X*) is ascertained by the optimizer by means of a trust-region method and/or a line-search method.

10. The method as claimed in claim 1, wherein it is checked whether the operation of the facility when the manufacturing process is carried out meets at least one specified criterion, and the optimized operating point (X*) of the facility is ascertained depending on a result of the check.

11. The method as claimed in claim 1, wherein the optimizer comprises an optimization algorithm and the optimization algorithm does not have a termination criterion.

12. A system for adapting a manufacturing process (P), in particular a hot rolling process, comprising
a facility, in particular a hot rolling facility, for producing a process product in that a manufacturing process (P) is carried out starting from a specified operating starting point (X) with the aid of the facility;
a means for ascertaining an actual product property (E) of the produced process product (2); and
an optimizer for iteratively solving an optimization problem using an optimization strategy, which is configured to ascertain an optimized operating point (X*) for the facility on the basis of a specified product property (E*) of the process product, which is characterized by a target value, and the ascertained actual product property (E), so that the ascertained optimized operating point (X′) can be specified as the operating starting point (X) or can be used as the basis of a specification of the operating starting point (X) when the manufacturing process (P) is carried out again.

13. The method as claimed in claim 5, wherein the manufacturing process (P) is carried out at the same operating point with the aid of the facility at least four times.

14. The method as claimed in claim 5, wherein the manufacturing process (P) is carried out at the same operating point with the aid of the facility at least five times.
